(19) United States
(12) Patent Application Publication
(10) Pub. No.: US 2026/0229577 A1
(43) Pub. Date: Aug. 6, 2026

(54) APPARATUS AND METHOD FOR ALIGNING ELECTRODES

(71) Applicant: SK ON CO., LTD., Seoul (KR)

(72) Inventors: Ki Sang YOO, Daejeon (KR); Won Je OH, Daejeon (KR); Moon Hyung JUNG, Daejeon (KR); Jae Sik SHIN, Daejeon (KR)

(21) Appl. No.: 19/530,343

(22) Filed: Feb. 5, 2026

(30) Foreign Application Priority Data
Feb. 5, 2025 (KR) 10-2025-0014663
Nov. 10, 2025 (KR) 10-2025-0168777

(51) Int. Cl. H01M 10/04; B65H 7/10; B65H 9/10

(52) U.S. Cl. CPC H01M 10/0409; B65H 7/10; B65H 9/10; H01M 10/0431; B65H 2220/01; B65H 2220/02; B65H 2301/33; B65H 2511/21; B65H 2513/10

(57) ABSTRACT

The present disclosure relates to an apparatus for aligning electrodes, which includes: a gripper unit configured to provide an electrode; a winding unit configured to wind the electrode; an observation unit positioned between the gripper unit and the winding unit and configured to determine a position value of the electrode; a transport unit positioned between the observation unit and the winding unit and configured to transport the electrode; and a control unit configured to control the gripper unit, wherein the control unit is configured to compensate for a tilt of the gripper unit such that the position value of the electrode converges to a preset reference position value, and to control a tilt compensation speed of the gripper unit based on the position value of the electrode.

### CROSS-REFERENCE TO RELATED APPLICATIONS

This patent application claims the priority and benefits of Korean patent applications No. 10-2025-0014663, filed on Feb. 5, 2025, and No. 10-2025-0168777, filed on Nov. 10, 2025, the disclosure of which is incorporated herein by reference in its entirety.

### BACKGROUND OF THE INVENTION

### 1. Field of the Invention

The present disclosure relates to an apparatus and a method for aligning electrodes for a secondary battery.

### 2. Description of the Related Art

The usage and application fields of batteries are rapidly expanding. As battery capacity significantly increases, battery modules in which a plurality of battery cells are electrically connected and battery packs in which a plurality of battery modules are electrically connected as unit modules are used in medium- to large-sized devices.

The battery cells that constitute a battery module may generate a large amount of heat during charging and discharging processes, or due to various causes, such as a short circuit or being left at a high temperature.

The battery cell includes an electrode assembly. The electrode assembly includes a cathode plate, an anode plate, and a separator. The electrode assembly may be wound to form a jelly roll.

### SUMMARY OF THE INVENTION

An object of the present disclosure is to provide an apparatus and a method for aligning electrodes that may improve electrode alignment precision.

Another object of the present disclosure is to provide an apparatus and a method for aligning electrodes that may compensate for electrode skew.

An apparatus for aligning electrodes according to an embodiment of the present disclosure may include: a gripper unit configured to provide an electrode; a winding unit configured to wind the electrode; an observation unit positioned between the gripper unit and the winding unit and configured to determine a position value of the electrode; a transport unit positioned between the observation unit and the winding unit and configured to transport the electrode; and a control unit configured to control the gripper unit, wherein the control unit may be configured to compensate for a tilt of the gripper unit such that the position value of the electrode converges to a preset reference position value, and to control a tilt compensation speed of the gripper unit based on the position value of the electrode.

In one embodiment, the observation unit may determine an edge position value of the electrode used for edge position control (EPC).

In one embodiment, the observation unit may determine a first position value of the electrode at a first position and a second position value of the electrode at a second position, and the control unit may derive the position value of the electrode from the first position value and the second position value.

In one embodiment, the control unit may control the tilt compensation speed of the gripper unit based on a difference between the first position value and the second position value.

In one embodiment, the control unit may decrease the tilt compensation speed of the gripper unit as the difference between the first position value and the second position value increases.

In one embodiment, the control unit may control operation of the transport unit.

In one embodiment, the control unit may control a start time of operation of the transport unit based on the difference between the first position value and the second position value.

In one embodiment, the control unit may delay the start time of operation of the transport unit as the difference between the first position value and the second position value increases.

In one embodiment, the control unit may control the position of the transport unit based on the position value of the electrode.

In one embodiment, the control unit may compensate for the tilt of the gripper unit before the electrode reaches the winding unit.

In one embodiment, the control unit may return the tilt of the gripper unit to an initial tilt when the electrode is wound.

A method for aligning electrodes according to an embodiment of the present disclosure may include: providing, by a gripper unit, an electrode toward a winding unit in which the electrode is wound; determining, by an observation unit, a position value of the electrode; compensating for, by a control unit, a tilt of the gripper unit such that the position value of the electrode converges to a preset reference position value, and controlling, by the control unit, a tilt compensation speed of the gripper unit; and transporting, by a transport unit, the electrode toward the winding unit.

In one embodiment, the observation unit may determine a first position value of the electrode at a first position and a second position value of the electrode at a second position, and the control unit may derive the position value of the electrode from the first position value and the second position value.

In one embodiment, the control unit may control the tilt compensation speed of the gripper unit based on a difference between the first position value and the second position value.

In one embodiment, the control unit may decrease the tilt compensation speed of the gripper unit as the difference between the first position value and the second position value increases.

In one embodiment, the control unit may control a start time of operation of the transport unit based on the difference between the first position value and the second position value.

In one embodiment, the control unit may delay the start time of operation of the transport unit as the difference between the first position value and the second position value increases.

In one embodiment, the control unit may control the position of the transport unit based on the position value of the electrode.

According to an embodiment of the present disclosure, electrodes may be aligned before they are wound to form a jelly roll.

According to an embodiment of the present disclosure, the alignment of the electrodes may be improved during winding.

According to an embodiment of the present disclosure, an electrode defect rate in the electrode winding process may be reduced.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic plan view illustrating an apparatus for aligning electrodes (hereinafter, referred to as an “electrode alignment apparatus”) according to an embodiment of the present disclosure;

FIG. 2 is a schematic plan view illustrating a state in which an electrode shown in FIG. 1 is moved;

FIG. 3 is a schematic side view illustrating the electrode alignment apparatus shown in FIG. 2;

FIG. 4 is a schematic plan view illustrating a state in which the electrode shown in FIG. 2 is aligned;

FIG. 5 is a schematic plan view illustrating a state in which the electrode shown in FIG. 4 is moved;

FIG. 6 is a schematic side view illustrating the electrode alignment apparatus shown in FIG. 5;

FIG. 7 is a schematic plan view illustrating a pivoted state of a gripper unit;

FIG. 8 is a schematic plan view illustrating a state in which an aligned electrode is wound;

FIG. 9 is a block diagram schematically illustrating an internal control configuration of the electrode alignment apparatus according to an embodiment of the present disclosure; and

FIG. 10 is a flowchart illustrating a method for aligning electrodes (hereinafter, referred to as an “electrode alignment method”) according to an embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

In this specification, an XYZ coordinate system may be used. For example, the XYZ coordinate system may include an X-axis, a Y-axis, and a Z-axis. The XYZ coordinate system may be a Cartesian coordinate system.

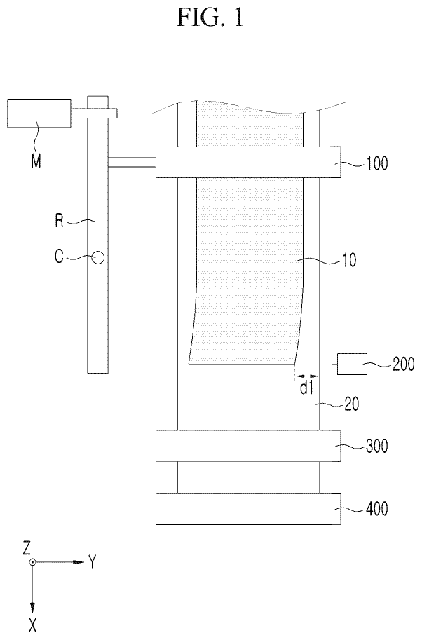

In this specification, a first direction, a second direction, and a height direction may be set based on FIG. 1. The first direction may be parallel to the X-axis. For example, the first direction may be a front-rear direction. A positive X-axis direction may represent a forward direction, and a negative X-axis direction may represent a rearward direction.

The second direction may be parallel to the Y-axis. For example, the second direction may be left-right direction. A positive Y-axis direction may represent a leftward direction. A negative Y-axis direction may represent a rightward direction.

The height direction may be parallel to the Z-axis. For example, a positive Z-axis direction may represent an upward direction. For example, a negative Z-axis direction may represent a downward direction.

However, if the orientation of the corresponding object is changed, the directions may be defined differently.

The present disclosure relates to an electrode alignment apparatus for aligning electrodes during transport of the electrodes in an assembly process of an electrode assembly (not shown) that constitutes a secondary battery.

The electrode alignment apparatus according to an embodiment of the present disclosure may form an electrode assembly by disposing electrodes on a separator.

For example, an electrode assembly assembled using the electrode alignment apparatus of the present disclosure may include a first electrode, a second electrode, and a separator. The first electrode and the second electrode may each be provided in a plate shape. The first electrode and the second electrode may each include a current collector and a coating layer in which an active material is coated on the current collector.

The first electrode may be either a cathode or an anode. If the first electrode is a cathode, the second electrode may be an anode. If the first electrode is an anode, the second electrode may be a cathode.

In one embodiment, the first electrode may be a cathode. The first electrode may include a first current collector in the form of a metal foil and a first coating layer on which a cathode active material is coated. For example, the first current collector may be a cathode current collector including aluminum.

In one embodiment, the first coating layer may be a cathode coating layer on which an electrically conductive material is coated. The first coating layer may include a cathode active material. For example, the cathode active material may include a lithium-nickel metal oxide.

In one embodiment, the second electrode may be an anode. The second electrode may include a second current collector in the form of a metal foil and a second coating layer on which an anode active material is coated. For example, the second current collector may be an anode current collector. The second current collector may include copper or nickel.

In one embodiment, the second coating layer may be an anode coating layer on which an electrically conductive material is coated. The second coating layer may include an anode active material. For example, the anode active material may include a silicon material, a carbon-based material, a tin-based material, or a metal oxide. A separator may be interposed between the first electrode and the second electrode. The separator may be configured to prevent an electrical short-circuit between the first electrode and the second electrode, and to allow the flow of ions.

For example, the separator may include an electrically insulating material. For example, the separator may include a polymeric material. For example, the separator may include polyethylene, polypropylene, or a combination thereof.

The first electrode and the second electrode may be stacked on the separator. The first electrode and the second electrode may be alternately stacked based on the separator to form an electrode assembly.

Hereinafter, the electrode alignment apparatus according to an embodiment of the present disclosure will be described in detail with reference to the accompanying drawings.

Except where otherwise specifically described, an electrode 10 aligned by the electrode alignment apparatus of the present disclosure described below does not specifically refer to either the first electrode or the second electrode described above. For example, the electrode 10 may be the first electrode or the second electrode among the electrodes 10 constituting the electrode assembly.

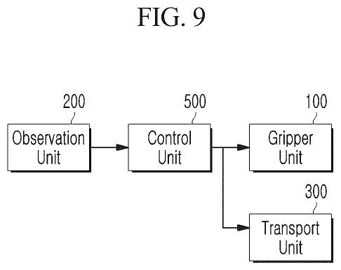

Referring to FIGS. 1 to 9, the electrode alignment apparatus according to an embodiment of the present disclosure may include a gripper unit 100, a winding unit 400, an observation unit 200, a transport unit 300, and a control unit 500.

The gripper unit 100 may hold and provide the electrode 10.

The gripper unit 100 may extend in the second direction. The second direction may correspond to a width direction of the electrode 10.

The gripper unit 100 may be coupled to a pivot axis R. The gripper unit 100 may move along the pivot axis R in one direction. The gripper unit 100 may reciprocate along the pivot axis R in the first direction. The gripper unit 100 may move along the pivot axis R in one direction to provide the electrode 10.

The pivot axis R may be pivotable about a central axis C. The gripper unit 100 may be pivoted by pivoting the pivot axis R. Pivoting of the gripper unit 100 may cause the electrode held by the gripper unit 100 to pivot.

The electrode 10 may be fixed to and provided by the gripper unit 100.

The winding unit 400 may wind the electrode 10. The winding unit 400 may rotate about a winding axis (not shown). The winding unit 400 may be connected to a separate driving member, such as a motor, to be rotated thereby, and the driving member may be built into the winding unit 400.

The electrode 10 may be wound onto the winding unit 400 by rotation of the winding unit 400. The winding unit 400 may wind the electrode 10 and provide the electrode 10 in a jelly-roll form.

The electrode 10 may be wound together with a separator 20. The electrode 10 may be provided on an upper side of the separator 20. The separator 20 may be transported toward the winding unit 400 by guide rollers (not shown) disposed on a lower side of the separator 20. When the electrode 10 and the separator 20 are not wound together, the electrode 10 may not be provided on the upper side of the separator 20. In this case, although not illustrated in the drawings, the electrode 10 may be provided on a separate transport member such as a conveyor belt, or on a roller member such as the guide rollers.

The observation unit 200 may be disposed between the gripper unit 100 and the winding unit 400.

The observation unit 200 may determine a position value of the electrode 10. The observation unit 200 may include a position sensor configured to determine the position value of the electrode 10. For example, the observation unit 200 may be an edge position sensor (EPS). For example, the observation unit 200 may determine an edge position value of the electrode 10 used for edge position control (EPC).

Referring to FIG. 1, the edge position value of the electrode may be a distance determined in a direction parallel to the Y-axis from an edge of the separator 20 on which the electrode 10 is disposed to an edge of the electrode 10.

For example, a position value d of the electrode may be expressed as a distance.

The transport unit 300 may be disposed between the winding unit 400 and the observation unit 200. The transport unit 300 may transport the electrode 10 toward the winding unit 400. Operation of the transport unit 300 may be controlled to be turned on or off by the control unit 500, as will be described in detail below.

The transport unit 300 may be a roller configured to transport the electrode 10 toward the winding unit 400. The transport unit 300 may be disposed on an upper side of the electrode 10. The transport unit 300 may contact the electrode 10 to transport the electrode 10. The transport unit 300 may rotate to transport the electrode 10 in the first direction.

The control unit 500 may compensate for a tilt of the gripper unit 100. The control unit 500 may control the tilt of the gripper unit 100 by pivoting the pivot axis R. For example, the control unit 500 may control the tilt of the gripper unit 100 such that a determined edge position value of the electrode converges to a preset reference position value.

Convergence of a determined position value of the electrode 10 to the preset reference position value may mean that a difference between the determined position value of the electrode 10 and the preset reference position value is included within a specific range. For example, the specific range may be 0.3 mm. For example, when the difference between the determined position value of the electrode 10 and the preset reference position value is less than 0.3 mm, the determined position value of the electrode may be determined to converge to the preset reference position value. For example, when the difference between the determined position value of the electrode and the preset reference position value is 0.3 mm or more, the determined position value of the electrode may be determined not to converge to the preset reference position value.

The specific range for determining whether a position value of the electrode converges to the preset reference position value may be changed depending on conditions under which the electrode is provided. The specific range may be set as an absolute value or as a percentage.

The control unit 500 may control a tilt compensation speed of the gripper unit 100 based on the position value d of the electrode.

For example, the electrode 10 may be provided with an end portion thereof bent. Since tension cannot be applied to an initial winding portion of the electrode 10 (hereinafter, referred to as an end portion of the electrode), the end portion of the electrode 10 may be bent, as shown in FIG. 1. The electrode 10 may be provided by the gripper unit 100 in a state in which the end portion thereof is bent. Alternatively, the electrode 10 may be provided by the gripper unit 100, and the end portion may be bent during provision.

The observation unit 200 may determine a first position value d1 of the electrode 10 at a first position. The position of the electrode 10 may refer to the position of the end portion of the electrode 10. For example, the first position may be an initial position of the electrode 10. The first position value d1 of the electrode 10 may be an initial position value of the electrode 10. The initial position value of the electrode 10 may be a distance determined from an edge of the electrode 10 to an edge of the separator 20 at the initial position of the electrode 10.

The electrode 10 may be provided to the initial position by the gripper unit 100. The gripper unit 100 may reciprocate along the pivot axis R in the first direction (parallel to the X-axis). The control unit 500 may control movement of the gripper unit 100. The control unit 500 may control the movement of the gripper unit 100 such that the electrode 10 is positioned at the initial position by the gripper unit 100.

When the electrode 10 reaches the first position by the gripper unit 100, the observation unit 200 may observe and determine the first position value of the electrode 10. At this time, the position value d of the electrode 10 may be the edge position value thereof used for edge position control (EPC). The position value d of the electrode 10 may be determined as a distance.

The observation unit 200 may continuously determine the position value of the electrode 10 as the electrode 10 moves. The control unit 500 may continuously store the position value of the electrode 10 determined by the observation unit 200.

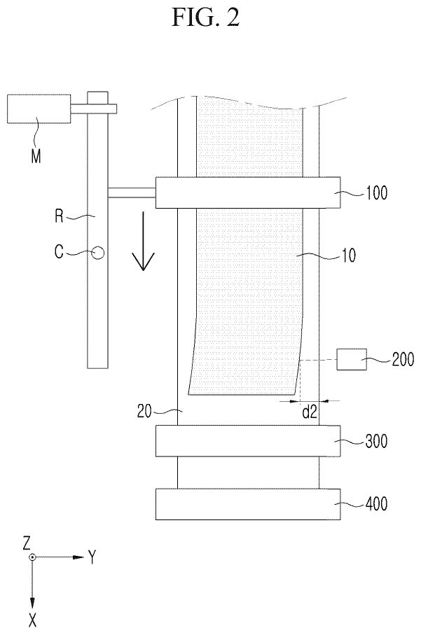

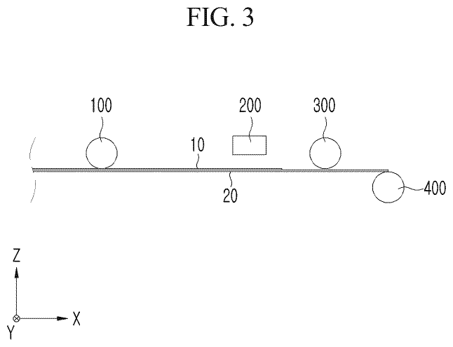

Referring to FIGS. 2 and 3, the gripper unit 100 may move the electrode 10 to a second position. The gripper unit 100 may move along the pivot axis R to move the electrode 10. The gripper unit 100 may move along the pivot axis R to move the electrode 10 in the first direction. When the electrode 10 reaches the second position, the observation unit 200 may determine a second position value d2 of the electrode 10 at the second position. The second position may be an arbitrary position. For example, the second position may be located between the first position and the transport unit 300.

The control unit 500 may receive the first position value d1 and the second position value d2 of the electrode 10 from the observation unit 200. The observation unit 200 may continuously determine the position value of the electrode 10. The control unit 500 may continuously receive position values corresponding to movement of the electrode 10 from the observation unit 200.

The control unit 500 may derive the position value d of the electrode 10 from the first position value d1 and the second position value d2. For example, the control unit 500 may derive the position value d of the electrode from a difference between the first position value d1 and the second position value d2. For example, the control unit 500 may derive an average value of the first position value d1 and the second position value d2 as the position value d of the electrode 10.

The control unit 500 may derive a tilt compensation angle θ of the gripper unit 100 based on Equation 1 below.

$$Δ∠ = C \frac{( {a}_{1} - {a}_{2} )}{2} \qquad [ Equation 1 ]$$

In Equation 1, Δ∠ denotes the tilt compensation angle θ of the gripper unit 100, C denotes a constant representing a relationship between a change in the position value d of the electrode 10 and tilt adjustment of the gripper unit 100, a₁ denotes the first position value d1 of the electrode, and a₂ denotes the second position value d2 of the electrode.

The control unit 500 may compensate for the tilt of the gripper unit 100 based on the tilt compensation angle θ derived from Equation 1. For example, the control unit 500 may pivot the pivot axis R by the tilt compensation angle θ derived from Equation 1. When the pivot axis R is pivoted, the gripper unit 100 fixed to the pivot axis R may be pivoted accordingly. The gripper unit 100 may be pivoted by the tilt compensation angle θ derived from Equation 1 under control of the control unit 500.

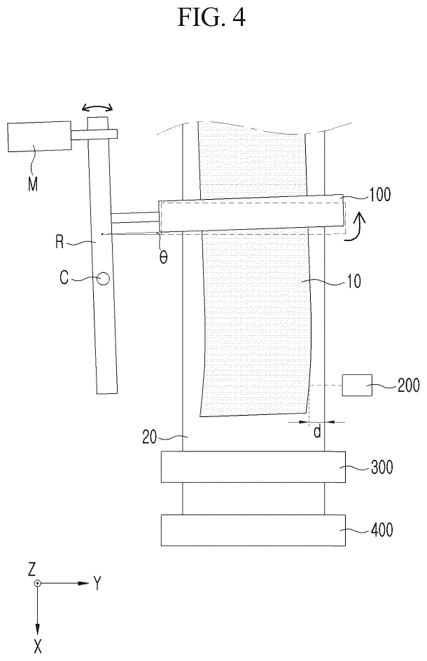

Referring to FIG. 4, the end portion of the electrode 10 may be aligned with a center of the separator 20 by pivoting the gripper unit 100. Here, the center of the separator 20 may refer to a central portion of the separator 20 in a width direction. Aligning the end portion of the electrode 10 with the center of the separator 20 may mean that distances from both ends of the end portion of the electrode 10 to respective edges of the separator 20 are equal. In other words, with reference to FIG. 4, aligning the electrode 10 with the center of the separator 20 may mean that a distance from one vertex of the end portion of the electrode 10 to an edge of the separator 20 is equal to a distance from another vertex of the end portion of the electrode 10 to the edge of the separator 20.

The control unit 500 may compensate for the tilt of the gripper unit 100 before the electrode 10 reaches the winding unit 400. The electrode 10 may be aligned under control of the control unit 500 before reaching the winding unit 400. Accordingly, the electrode 10 may be wound in an aligned state by the winding unit 400.

The control unit 500 may control a tilt compensation speed of the gripper unit 100 based on a difference between the first position value d1 and the second position value d2 of the electrode 10. For example, when a pivoting speed of the gripper unit 100 is high, a pivoting speed of the electrode 10 may also be increased. In this case, an increased pivoting speed of the electrode 10 may cause vibration or oscillation of the electrode 10. Accordingly, an error may occur in determination of the position value of the electrode 10.

A drive unit M may be connected to the pivot axis R. For example, the drive unit M may be a servo motor. The control unit 500 may control the drive unit M to control the pivoting speed of the pivot axis R.

The control unit 500 may decrease the tilt compensation speed of the gripper unit 100 as the difference between the first position value and the second position value increases. A larger difference between the first position value and the second position value may indicate that the electrode 10 is provided in a bent state. To align the electrode 10, a tilt angle of the gripper unit 100 may need to be increased, and a movement radius of the electrode 10 may increase accordingly. As a movement amount of the electrode 10 increases, an error in the position value may increase. Accordingly, the control unit 500 may decrease a movement speed of the electrode 10 to reduce an error in the position value.

For example, the control unit 500 may control the speed of the drive unit M to control the pivoting speed of the gripper unit 100. For example, the control unit 500 may reduce the speed of the drive unit M to reduce the tilt compensation speed of the gripper unit 100. Accordingly, by reducing the tilt compensation speed of the gripper unit 100, the movement speed of the electrode 10 may be reduced.

For example, when the difference between the first position value and the second position value is 0.3 mm or less, the control unit 500 may control the speed of the drive unit M to about 100 mm/s. For example, when the difference between the first position value and the second position value is greater than 0.3 mm and 0.5 mm or less, the control unit 500 may control the speed of the drive unit M to about 80 mm/s. For example, when the difference between the first position value and the second position value is greater than 0.5 mm and 0.8 mm or less, the control unit 500 may control the speed of the drive unit M to about 60 mm/s. For example, when the difference between the first position value and the second position value is greater than 0.8 mm, the control unit 500 may control the speed of the drive unit M to about 40 mm/s.

However, speed control of the drive unit based on the difference between the first position value and the second position value is not limited to the foregoing examples and may be changed depending on an electrode supply environment.

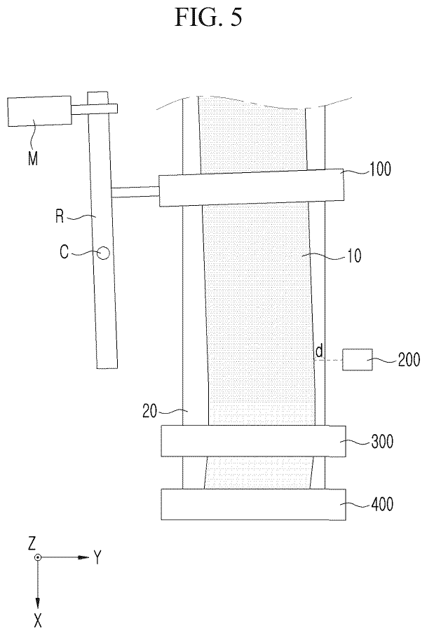

Referring to FIG. 5, the electrode 10 may be provided while being aligned with the center of the separator 20 by pivoting the gripper unit 100. After the electrode 10 is aligned with the center of the separator 20, the electrode 10 may be transported toward the winding unit 400 by the transport unit 300.

When the electrode 10 reaches the winding unit 400, the winding unit 400 may wind the electrode 10. The winding unit 400 may be connected to a driving member and be rotatable thereby. By rotation of the winding unit 400, the electrode 10 may be wound onto the winding unit 400. The winding unit 400 may be rotated under control of the control unit 500 to wind the electrode 10.

While the electrode 10 is wound by the winding unit 400, a position value of the electrode 10 may be determined by the observation unit 200. For example, the observation unit 200 may continuously determine the position value of the electrode 10. For example, the observation unit 200 may determine the position value of the electrode 10 discretely. The position value of the electrode 10 determined by the observation unit 200 may be transmitted to the control unit 500.

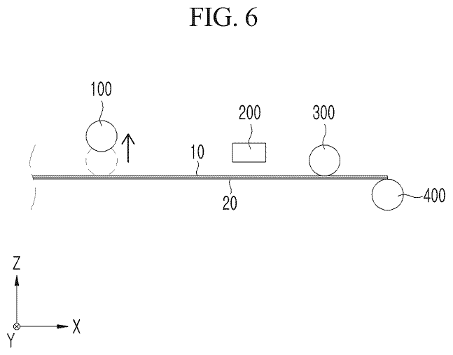

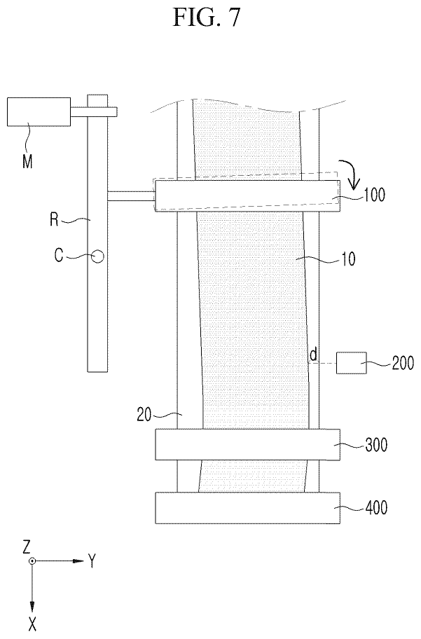

Referring to FIGS. 6 and 7, when the electrode 10 is wound by the winding unit 400, the gripper unit 100 may be separated from the electrode 10. For example, when the electrode 10 is wound by the winding unit 400, the gripper unit 100 may be moved upward under control of the control unit 500. The gripper unit 100 may be pivoted by pivoting the pivot axis R to an initial tilt. For example, the control unit 500 may pivot the pivot axis R such that the tilt of the gripper unit 100 returns to the initial tilt. The gripper unit 100 is fixed to the pivot axis R and may be pivoted by pivoting the pivot axis R. For example, the control unit 500 may pivot the gripper unit 100 such that the gripper unit 100 is aligned horizontally with the winding unit 400.

After the electrode 10 provided by the gripper unit 100 is wound, a subsequent electrode may be provided in an approximately horizontal state with respect to the winding unit 400 during winding. For example, the subsequent electrode may be provided parallel to the separator 20.

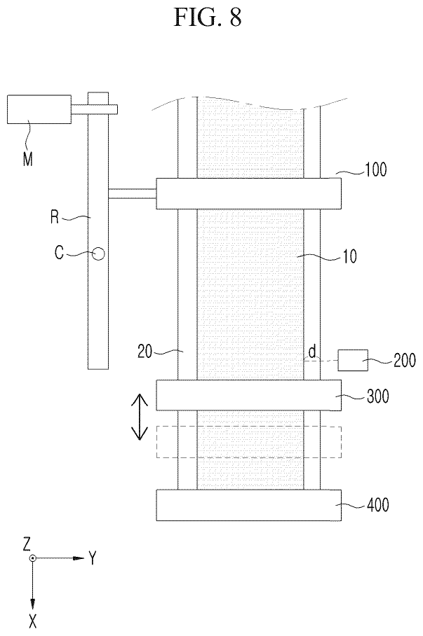

Referring to FIG. 8, the control unit 500 may control operation of the transport unit 300.

For example, the control unit 500 may control a start time of operation of the transport unit 300. The control unit 500 may control the start time of operation of the transport unit 300 based on the position value of the electrode 10. The control unit 500 may prevent the transport unit 300 from operating until the electrode 10 reaches the transport unit 300. After the electrode 10 reaches the transport unit 300, the control unit 500 may allow the transport unit 300 to operate. The electrode 10 may be provided to the transport unit 300 by the gripper unit 100.

The control unit 500 may control the start time of operation of the transport unit 300 based on the difference between the first position value d1 and the second position value d2. Delaying the start time of operation of the transport unit 300 may mean that the transport unit 300 does not operate even when the electrode 10 reaches the transport unit 300. For example, a delay of the start time of operation by 1 second may mean that the transport unit 300 starts operating 1 second after the electrode 10 reaches the transport unit 300.

The control unit 500 may delay the start time of operation of the transport unit 300 until alignment of the electrode 10 is stabilized. The end portion of the electrode 10 may be moved by the gripper unit 100, and the end portion of the electrode 10 may also move in accordance with movement of the gripper unit 100. For example, when the gripper unit 100 is pivoted, the end portion of the electrode 10 may also be pivoted. When the end portion of the electrode 10 moves, an error may occur in determination of the position value of the electrode 10, and an error may occur in determination of whether the electrode 10 is aligned. Accordingly, the control unit 500 may delay the start time of operation of the transport unit 300 until the electrode 10 is stably aligned.

For example, the control unit 500 may delay the start time of operation of the transport unit 300 as a difference between the first position value d1 and the second position value d2 increases.

For example, when the difference between the first position value and the second position value is 0.3 mm or less, the control unit 500 may delay the start time of operation of the transport unit 300 by about 0.1 seconds. For example, when the difference between the first position value and the second position value is greater than 0.3 mm and 0.5 mm or less, the control unit 500 may delay the start time of operation of the transport unit 300 by about 0.2 seconds. For example, when the difference between the first position value and the second position value is greater than 0.5 mm and 0.8 mm or less, the control unit 500 may delay the start time of operation of the transport unit 300 by about 0.4 seconds. For example, when the difference between the first position value and the second position value is greater than 0.8 mm, the control unit 500 may delay the start time of operation of the transport unit 300 by about 0.6 seconds.

However, a delay time of the start time of operation of the transport unit based on the difference between the first position value and the second position value is not limited to the foregoing examples and may be changed depending on an electrode supply environment.

The control unit 500 may control a position of the transport unit 300. For example, the control unit 500 may control the position of the transport unit 300 based on the position value of the electrode 10.

The transport unit 300 may reciprocate in the first direction. Although not illustrated in the drawings, the transport unit 300 may be coupled to a guide rail extending in the first direction. The transport unit 300 may reciprocate along the guide rail in the first direction under control of the control unit 500. For example, the control unit 500 may control the position of the transport unit 300 based on the position value of the electrode 10. The control unit 500 may control the position of the transport unit 300 based on the difference between the first position value and the second position value of the electrode 10.

The electrode 10 may be aligned by controlling the position of the transport unit 300. For example, the electrode 10 may be aligned by moving the position of the transport unit 300. When the end portion of the electrode 10 is aligned approximately with the center of the separator 20 and is wound by the winding unit 400, the electrode 10 may be wound in an inclined state rather than being wound parallel to the separator 20, as shown in FIG. 7. In this case, when the transport unit 300 is moved, the electrode 10 may be aligned parallel to the separator 20 by tension applied to the electrode 10. Here, alignment of the electrode 10 parallel to the separator 20 may mean that both edges of the electrode 10 are parallel to respective edges of the separator 20.

When the electrode 10 is wound by the winding unit 400, the position value of the electrode 10 may be observed and determined by the observation unit 200. Based on the position value of the electrode 10, the control unit 500 may derive a movement direction and a movement distance of the transport unit 300. The control unit 500 may align the electrode 10 to be parallel to the separator 20 by controlling the movement direction and the movement distance of the transport unit 300. Accordingly, the electrode 10 may be aligned and wound by movement of the transport unit 300.

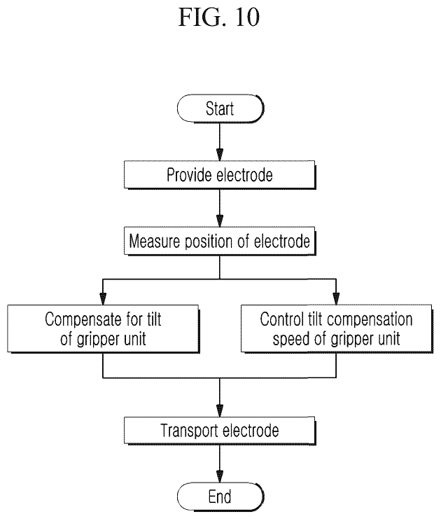

Hereinafter, an electrode alignment method according to an embodiment of the present disclosure will be described with reference to FIG. 10. Descriptions overlapping with the electrode alignment apparatus according to an embodiment of the present disclosure will be omitted.

The electrode alignment method according to an embodiment of the present disclosure may include the steps of providing an electrode, measuring a position value of the electrode, controlling a gripper unit by a control unit, and transporting the electrode by a transport unit.

In the step of providing the electrode, the gripper unit 100 may provide the electrode 10. The gripper unit 100 may provide the electrode 10 toward the winding unit 400.

When the electrode 10 is provided to the position of the observation unit 200, the observation unit 200 may determine a position value of the electrode 10. The observation unit 200 may determine a first position value of the electrode 10 at a first position. For example, the first position of the electrode 10 may be an initial position of the electrode 10. The initial position of the electrode 10 may be a position at which the observation unit 200 first determines the position of the electrode 10. Alternatively, the initial position of the electrode 10 may be any position of the electrode 10 that is determinable by the observation unit 200.

The position value of the electrode 10 may be determined as a distance. The position value of the electrode 10 may be an edge position value of the electrode 10. For example, the observation unit may be an edge position sensor (EPS).

The position value of the electrode 10 determined by the observation unit 200 may be transmitted to the control unit 500. The control unit 500 may compensate for the tilt of the gripper unit 100 based on the position value of the electrode 10 determined by the observation unit 200. The control unit 500 may control a tilt compensation speed of the gripper unit 100. A detailed description thereof is omitted since it has been described above.

When the electrode 10 is aligned under control of the control unit 500, the gripper unit 100 may provide the electrode 10 until the electrode 10 reaches the transport unit 300. The transport unit 300 may transport the electrode 10 toward the winding unit 400. The winding unit 400 may wind the electrode 10.

According to an embodiment of the present disclosure, the electrode 10 may be aligned and wound together with the separator 20 by the winding unit 400. For example, the tilt of the gripper unit 100 may be compensated by the control unit 500 such that the electrode 10 may be aligned and wound. The control unit 500 may control a tilt compensation speed of the gripper unit 100 to improve the alignment accuracy of the electrode 10. A position value of the electrode 10 may be determined by the observation unit 200 even while the electrode 10 is being wound. Based on the position value of the electrode 10, the control unit 500 may improve the alignment accuracy of the electrode 10 by controlling the start time of operation of the transport unit 300 or the position of the transport unit 300.

While the preferred embodiments of the present invention have been described in detail above, the scope of the present disclosure is not limited thereto. Various modifications and improvements made by those skilled in the art, utilizing the basic concepts of the present disclosure defined in the following claims, also fall within the scope of the present disclosure.

What is claimed is:

1. An apparatus for aligning electrodes comprising:
a gripper unit configured to provide an electrode;
a winding unit configured to wind the electrode;
an observation unit positioned between the gripper unit and the winding unit and configured to determine a position value of the electrode;
a transport unit positioned between the observation unit and the winding unit and configured to transport the electrode; and
a control unit configured to control the gripper unit,
wherein the control unit is configured to compensate for a tilt of the gripper unit such that the position value of the electrode converges to a preset reference position value, and to control a tilt compensation speed of the gripper unit based on the position value of the electrode.

2. The apparatus for aligning electrodes according to claim 1, wherein the observation unit determines an edge position value of the electrode used for edge position control (EPC).

3. The apparatus for aligning electrodes according to claim 1, wherein the observation unit determines a first position value of the electrode at a first position and a second position value of the electrode at a second position, and
the control unit derives the position value of the electrode from the first position value and the second position value.

4. The apparatus for aligning electrodes according to claim 3, wherein the control unit controls the tilt compensation speed of the gripper unit based on a difference between the first position value and the second position value.

5. The apparatus for aligning electrodes according to claim 4, wherein the control unit decreases the tilt compensation speed of the gripper unit as the difference between the first position value and the second position value increases.

6. The apparatus for aligning electrodes according to claim 3, wherein the control unit controls operation of the transport unit.

7. The apparatus for aligning electrodes according to claim 6, wherein the control unit controls a start time of operation of the transport unit based on the difference between the first position value and the second position value.

8. The apparatus for aligning electrodes according to claim 7, wherein the control unit delays the start time of operation of the transport unit as the difference between the first position value and the second position value increases.

9. The apparatus for aligning electrodes according to claim 6, wherein the control unit controls the position of the transport unit based on the position value of the electrode.

10. The apparatus for aligning electrodes according to claim 1, wherein the control unit compensates for the tilt of the gripper unit before the electrode reaches the winding unit.

11. The apparatus for aligning electrodes according to claim 10, wherein the control unit returns the tilt of the gripper unit to an initial tilt when the electrode is wound.

12. A method for aligning electrodes comprising:
providing, by a gripper unit, an electrode toward a winding unit in which the electrode is wound;
determining, by an observation unit, a position value of the electrode;
compensating for, by a control unit, a tilt of the gripper unit such that the position value of the electrode converges to a preset reference position value, and controlling, by the control unit, a tilt compensation speed of the gripper unit; and
transporting, by a transport unit, the electrode toward the winding unit.

13. The method for aligning electrodes according to claim 12, wherein the observation unit determines a first position value of the electrode at a first position and a second position value of the electrode at a second position, and
the control unit derives the position value of the electrode from the first position value and the second position value.

14. The method for aligning electrodes according to claim 13, wherein the control unit controls the tilt compensation speed of the gripper unit based on a difference between the first position value and the second position value.

15. The method for aligning electrodes according to claim 14, wherein the control unit decreases the tilt compensation speed of the gripper unit as the difference between the first position value and the second position value increases.

16. The method for aligning electrodes according to claim 13, wherein the control unit controls a start time of operation of the transport unit based on the difference between the first position value and the second position value.

17. The method for aligning electrodes according to claim 16, wherein the control unit delays the start time of operation of the transport unit as the difference between the first position value and the second position value increases.

18. The method for aligning electrodes according to claim 12, wherein the control unit controls the position of the transport unit based on the position value of the electrode.
